(19) United States
(12) Patent Application Publication
(10) Pub. No.: US 2026/0082381 A1
(43) Pub. Date: Mar. 19, 2026

(54) JOINT SCHEDULING OF DATA CHANNEL ON MULTIPLE BANDWIDTH PARTS

(71) Applicant: Intel Corporation, Santa Clara, CA (US)

(72) Inventors: Gang XIONG, Hillsboro, OR (US); Debdeep CHATTERJEE, San Jose, CA (US); Dae Won LEE, Portland, OR (US)

(21) Appl. No.: 19/397,061

(22) Filed: Nov. 21, 2025

Related U.S. Application Data
(60) Provisional application No. 63/746,761, filed on Jan. 17, 2025.

(51) Int. Cl. H04W 72/0457; H04W 72/232

(52) U.S. Cl. CPC H04W 72/0457; H04W 72/232

(57) ABSTRACT

This disclosure discloses a joint scheduling of data channel on multiple bandwidth parts. The disclosure provides an apparatus comprising interface circuitry; and processor circuitry coupled with the interface circuitry. The processor circuitry is to: monitor a physical downlink control channel (PDCCH) on a bandwidth part (BWP) via the interface circuitry; decode a downlink control information (DCI) in the PDCCH; and receive, in response to at least one field in the DCI indicating to schedule multiple physical downlink shared channels (PDSCHs) and/or physical uplink shared channels (PUSCHs) on a plurality of concurrently active BWPs, the PDSCHs on the plurality of concurrently active BWPs via the interface circuitry. Other embodiments are also disclosed and claimed.

### PRIORITY CLAIM

This application is based on and claims priority to U.S. provisional patent application No. 63/746,761 filed on Jan. 17, 2025, which is incorporated herein by reference in its entirety.

### TECHNICAL FIELD

Embodiments of the present disclosure generally relate to the third generation partnership project (3GPP) radio access network 1 (RAN1) work and/or sixth generation (6G) networks, and in particular to apparatus, and method for joint scheduling of data channel on multiple bandwidth parts.

### BACKGROUND

New radio (NR) may support a wide range of spectrum in different frequency ranges. Increasing availability of spectrum in the market for fifth generation (5G) Advanced is expected, possibly due to re-farming from the bands originally used for previous cellular generation networks. Especially for some frequency range 1 (FR1) bands, the available spectrum blocks may be more fragmented or scattered and have a narrower bandwidth. For frequency range 2 (FR2) bands and some other FR1 bands, the available spectrum is typically wider, making intra-band multi-carrier operation necessary. To meet different spectrum needs, it is important to ensure that these scattered spectrum bands or wider bandwidth spectra can be utilized in a more spectral/power efficient and flexible manner, thus providing higher throughput and decent coverage in the network.

For sixth generation (6G), with more available scattered spectrum bands, simultaneous scheduling of physical uplink shared channel (PUSCH) or physical downlink shared channel (PDSCH) transmissions in multiple spectrum bands can be considered, which may help reduce control overhead. To enable more efficient operation, multiple spectrum bands may be grouped into a single wideband or carrier.

### BRIEF DESCRIPTION OF THE DRAWINGS

Embodiments of the disclosure may be illustrated, by way of example and not limitation, in the figures of the drawings, in which like reference numerals refer to similar elements.

FIG. 1 schematically illustrates an example of a wideband carrier with fragmented bandwidth, in accordance with some embodiments.

FIG. 2 schematically illustrates an example of joint scheduling of PDSCHs on two BWPs, in accordance with some embodiments.

FIG. 3 schematically illustrates a process relating to a user equipment (UE) as described herein.

FIG. 4 schematically illustrates a process relating to a base station (BS) as described herein.

FIG. 5 schematically illustrates an example of a network, which may operate in a manner consistent with third generation partnership project (3GPP) technical specifications for long term evolution (LTE) or fifth generation (5G)/new radio (NR) systems, in accordance with some embodiments.

FIG. 6 schematically illustrates an example of a wireless network in accordance with some embodiments.

FIG. 7 schematically illustrates an example of a block diagram of hardware resources in accordance with some embodiments.

FIG. 8 schematically illustrates an example of a network, which may operate in a manner consistent with 3GPP technical specifications or technical reports for sixth generation (6G) systems, in accordance with some embodiments.

### DETAILED DESCRIPTION

Various aspects of the illustrative embodiments may be described using terms commonly employed by those skilled in the art to convey the substance of the disclosure. However, it will be apparent to those skilled in the art that many alternate embodiments may be practiced using portions of the described aspects. However, it will be apparent to those skilled in the art that alternate embodiments may be practiced without the specific details. In other instances, well-known features may have been omitted or simplified to avoid obscuring the illustrative embodiments.

Further, various operations described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A, B or C” and “A/B/C” mean “(A), (B), (C), (A and B), (A and C), (B and C) or (A, B and C).”

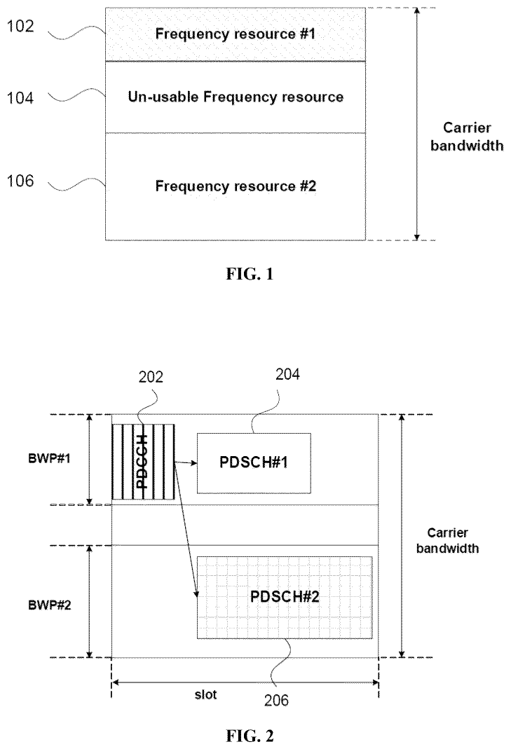

FIG. 1 illustrates an example wideband carrier with fragmented bandwidth. In the figure, a first frequency resource at 102 and a second frequency resource at 106 are grouped into a wideband carrier. In addition, between the first and second frequency resource, the frequency resource at 104 may be reserved and not used for cellular communication. In this case, the frequency resource at 104 is unavailable within the wideband carrier.

For a wideband carrier with fragmented bandwidth, it may be beneficial to consider the support of multiple bandwidth parts (BWP) for downlink (DL) and/or uplink (UL) data transmissions. In this case, certain mechanisms may be defined to allow scheduling of DL and/or UL data transmission within multiple BWPs. Embodiments herein may relate to joint scheduling on multiple bandwidth parts or enhanced scheduling for a wide BWP in a wideband carrier.

### Mechanisms for Joint Scheduling on Multiple Bandwidth Parts

Example embodiments of mechanisms for joint scheduling on multiple bandwidth parts may include one or more of the following:

In some embodiments, a downlink control information (DCI) may be used to schedule more than one physical downlink shared channel (PDSCH) and/or physical uplink shared channel (PUSCH) on a plurality of BWPs in a carrier, where one PDSCH and/or PUSCH may be transmitted on one BWP in the carrier.

In this case, when PDSCHs and/or PUSCHs are scheduled on a plurality of BWPs, the plurality of BWPs may be active at the same time.

In some options, a user equipment (UE) may monitor physical downlink control channel (PDCCH) on a BWP that is configured by the higher layer via system information, e.g., remaining minimum system information (RMSI) and/or other system information (OSI), or via dedicated radio resource control (RRC) signaling. The BWP where UE monitors the PDCCH may or may not be one of the BWPs for data transmission.

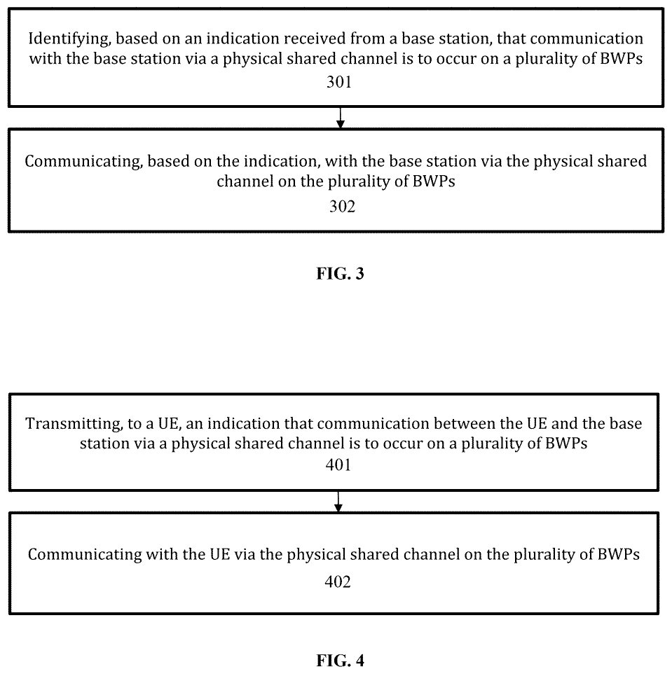

FIG. 2 illustrates one example of joint scheduling of PDSCHs on two BWPs. In the example, PDCCH at 202 is used to schedule PDSCH #1 at 204 in BWP #1 and PDSCH #2 at 206 in BWP #2. In this case, BWP #1 and BWP #2 are active for PDSCH transmissions.

In some aspects, a UE may expect that for multiple-BWP scheduling, a plurality of BWPs that are co-scheduled in the DCI do not overlap or separate from each other in the frequency domain. Further, the numerology, including subcarrier spacing and cyclic prefix (CP) types or duration(s), may be the same for the plurality of BWPs that are co-scheduled in the DCI for multiple-BWP scheduling.

In some embodiments, one or more types of fields for multiple-BWP scheduling may be introduced as follows:

Type 1: A single field may be included in the DCI that can be used to indicate common information for all the co-scheduled BWPs. Furthermore, the size of the Type 1 field can be determined based on the maximum field size among the field sizes of all configured BWPs for multiple-BWP scheduling.

Type 2: A single field may be included in the DCI that can be used to indicate separate information to each of the co-scheduled BWPs via joint indication. In this case, a table may be configured by higher layers, for example, via radio resource control (RRC) signaling. Furthermore, the single field may be used to indicate one row of the table. The size of the Type 2 field may be determined based on the number of rows of the table. In particular, the size of the Type 2 field can be determined as ┌log₂ N┐ bits, where N is the number of rows configured for the table, log₂ x represents the logarithmic function with base 2, and ┌⋅┐ represents the ceiling operation.

Type 3: A single field may be included in the DCI that can be used to indicate information to only one of the co-scheduled BWPs.

Type 4: Separate fields may be included in the DCI, where each of the fields is used to indicate information corresponding to one of the co-scheduled BWPs.

Further, for some fields in the DCI for multiple-BWP scheduling, a parameter may be configured by RRC signaling to indicate whether one of the field types described above can be applied to the fields in the DCI. For example, a parameter may be configured to indicate that either Type 1 or Type 2 may be applied to a field in the DCI.

In some embodiments, one or more fields below may be included in the multiple-BWP scheduling:
Identifier for DCI formats
Cell indicator
Hybrid automatic repeat request (HARQ) process number
Modulation and coding scheme (MCS)
New data indicator (NDI)
Redundancy version (RV)
Time domain resource assignment (TDRA)
Frequency domain resource assignment (FDRA)
Virtual resource block (VRB)-to-physical resource block (PRB) mapping
PRB bundling size indicator
Rate matching indicator
Zero power channel state information reference signal (ZP CSI-RS) trigger
Antenna port(s)
Transmission configuration indication
Demodulation reference signal (DMRS) sequence initialization
Frequency hopping flag
Transmit Power Control (TPC) command for scheduled PUSCH
Precoding information and number of layers
Phase tracking reference signal (PTRS)-DMRS association
Sounding reference signal (SRS) request
SRS resource indicator
SRS offset indicator
PTRS-DMRS association
Open-loop power control parameter set indication
UL/Supplementary Uplink (SUL) indicator.

In this case, the fields above, such as Identifier for DCI formats, in the DCI format for multiple-BWP scheduling may be one of the Type 1, Type 2, Type 3, and Type 4 fields as mentioned above.

In some embodiments, for multiple-BWP scheduling, a set of BWPs may be configured by higher layers, e.g., via radio resource control (RRC) signaling. Furthermore, a table for more than one combination of scheduled BWPs from the set of BWPs may be configured by higher layers, for example, via RRC signaling, where each entry of the table may indicate one specific combination of scheduled BWPs from the set of BWPs.

In addition, one field may be included in the DCI to indicate one entry with the corresponding combination of scheduled BWPs for the multiple-BWP scheduling of PDSCH and/or PUSCH transmissions.

Table 1 illustrates some examples of the BWP indicator for the multiple-BWP scheduling of PDSCH and/or PUSCH transmissions. In the example, bit field “00” may be used to indicate the first entry of the table, i.e., BWP #0 and BWP #1; bit field “01” may be used to indicate the second entry of the table, i.e., BWP #0 and BWP #2; bit field “10” may be used to indicate the third entry of the table, i.e., BWP #0 and BWP #3; bit field “10” may be used to indicate the fourth entry of the table, i.e., BWP #1 and BWP #2.

TABLE 1
BWP indicator

| Bit field | BWP indicator field |
|---|---|
| 00 | BWP#0, BWP#1 |
| 01 | BWP#0, BWP#2 |
| 10 | BWP#0, BWP#3 |
| 11 | BWP#1, BWP#2 |

In some options, the BWP where UE monitors for PDCCH is always included in the set of BWPs for the multiple-BWP scheduling of PDSCH and/or PUSCH transmissions.

In another option, only one scheduled BWP may be included in one entry of the table for BWP indication. In this case, dynamic switching between single BWP and multiple-BWP scheduling may be enabled.

In some embodiments, for multiple-BWP scheduling, a common time domain resource allocation (TDRA) may be applied for the transmission of PDSCH and/or PUSCH on more than one BWP. In this case, the same TDRA may be used for the PDSCH and/or PUSCH transmission in different BWPs.

In another embodiment, a joint frequency domain resource assignment (FDRA) may be used to indicate the frequency resource used for the PDSCH and/or PUSCH transmissions on more than one BWP. The resource allocation in frequency may be determined in accordance with the carrier that includes more than one BWP for multiple-BWP scheduling. In this case, the field size of frequency domain resource assignment for PDSCH and/or PUSCH transmissions on a first and a second BWP is determined based on the number of PRBs in the carrier.

In another embodiment, a separate frequency domain resource assignment may be used to indicate the frequency resource used for the PDSCH and/or PUSCH transmissions on more than one BWP.

In this case, frequency resource allocation for the PDSCH and/or PUSCH transmissions on a first and a second BWP is determined in accordance with the first and the second indicated BWP, respectively. In particular, the field size of frequency domain resource assignment for the PDSCH and/or PUSCH transmissions on a first and a second BWP is determined based on the number of PRBs for the first and the second indicated BWP, respectively.

In some examples, for resource indicator value (RIV)-based resource allocation (e.g., resource allocation type 1 in NR), the field size of the frequency domain resource allocation in a first and a second indicated BWP may be determined as

$$⌈ {log}_{2} ( {N}_{R B}^{BWP , 1} ( {N}_{R B}^{BWP , 1} + 1 ) / 2 ) ⌉ and$$

$$⌈ {log}_{2} ( {N}_{R B}^{BWP , 2} ( {N}_{R B}^{BWP , 2} + 1 ) / 2 ) ⌉ ,$$

respectively, where

$${N}_{R B}^{BWP , 1} and {N}_{R B}^{BWP , 2}$$

are the number of PRBs for the first and the second BWP, respectively, log₂ x represents the logarithmic function with base 2, and ┌⋅┐ represents the ceiling operation.

In another embodiment, the frequency domain resource assignment (FDRA) field in the DCI format for multiple-BWP scheduling may be used to indicate one BWP or a plurality of BWPs for PDSCH and/or PUSCH transmission. In this case, the actually scheduled BWPs from the set of BWPs that are configured for multiple-BWP scheduling may be determined in accordance with the frequency domain resource assignment field in the DCI.

In one example, for resource allocation type 0, all bits “0” in the FDRA field for a BWP may be used to indicate that the BWP is not scheduled, while for resource allocation type 1, all bits “1” in the FDRA field for a BWP may be used to indicate that the BWP is not scheduled. For dynamic switch resource allocation type, either bits “0” or “1” in the FDRA field for a BWP may be used to indicate that the BWP is not scheduled.

In this option, the payload size of the DCI format for multiple-BWP scheduling may be determined based on the set of BWPs that are configured for multiple-BWP scheduling.

In another embodiment, for a cell that supports multiple-BWP scheduling, a UE can monitor DCI format 0_0/1_0, 0_1/1_1, 0_2/1_2, and the DCI formats for multiple-BWP scheduling simultaneously.

In another embodiment, for multiple-BWP scheduling, the modulation and coding scheme (MCS) and/or redundancy version (RV) and/or HARQ process identifier (ID) may be separately included in the DCI format. In particular, a first MCS, a first RV, and/or a first HARQ process ID may be applied to a first PDSCH and/or a first PUSCH transmission on a first BWP, while a second MCS, a second RV, and/or a second HARQ process ID may be applied to a second PDSCH and/or a second PUSCH transmission on a second BWP.

In another option, a first MCS and a delta MCS (or a MCS offset) may be included in the DCI format for multiple-BWP scheduling. Particularly, the second MCS (denoted as MCS₂) can be calculated from the first MCS (denoted as MCS₁) and the delta MCS (denoted as Δ_{MCS}) using the formula: MCS₂=MCS₁+Δ_{MCS}.

In some embodiments, the payload size of the DCI format for multiple-BWP scheduling is determined in accordance with the BWP combination table for BWP indication within the cell. In particular, the payload size of the DCI format for multiple-BWP scheduling is equal to the largest of the payload sizes associated with each entry (i.e., each BWP combination) in the table configured for multiple-BWP scheduling.

In addition, if the required payload size of the DCI format for multiple-BWP scheduling for a BWP combination (i.e., an entry of the table) is less than the largest one, zero padding is applied to the DCI format.

Further, if the determined payload size of the DCI format for multiple-BWP scheduling for PDSCH is less than that for PUSCH, zero padding is applied to the DCI format for PDSCH. Conversely, if the determined payload size of the DCI format for PUSCH is less than that for PDSCH, zero padding is applied to the DCI format for PUSCH.

The following example procedures are provided to further illustrate embodiments of the present disclosure.

### Example Procedures

FIG. 3 schematically illustrates a process as described herein. The process of FIG. 3 may include or relate to a method to be performed by a user equipment (UE), one or more elements of a UE, and/or one or more electronic devices that include and/or implement a UE. The process may include identifying, at 301 based on an indication received from a base station, that communication with the base station via a physical shared channel is to occur on a plurality of bandwidth parts (BWPs); and communicating, at 302 based on the indication, with the base station via the physical shared channel on the plurality of BWPs.

FIG. 4 schematically illustrates another process as described herein. The process of FIG. 4 may include or relate to a method to be performed by a BS, one or more elements of a BS, and/or one or more electronic devices that include and/or implement a BS. The process may include transmitting, at 401 to a user equipment (UE), an indication that communication between the UE and the base station via a physical shared channel is to occur on a plurality of bandwidth parts (BWPs); and communicating, at 402, with the UE via the physical shared channel on the plurality of BWPs.

Various networks, systems, devices, and components that may implement aspects of the embodiments herein are provided below.

### Network, Components, and Implementations

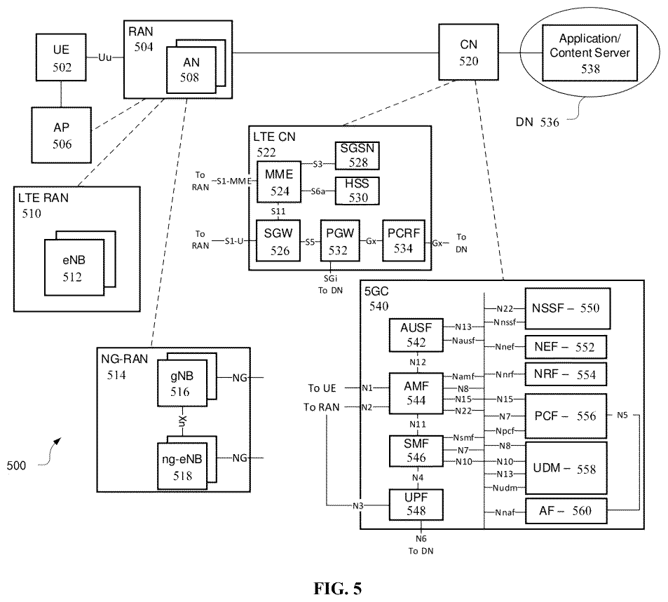

FIG. 5 illustrates a network 500 that may implement some embodiments of the disclosure. The network 500 may operate in a manner consistent with 3GPP technical specifications for LTE or 5G/NR systems.

The network 500 may include a UE 502, which may include any mobile or non-mobile computing device designed to communicate with a RAN 504 via an over-the-air connection. The UE 502 may be communicatively coupled with the RAN 504.

In some embodiments, the network 500 may include a plurality of UEs coupled directly with one another via a sidelink interface. The UEs may be Machine-to-Machine (M2M)/Device-to-Device (D2D) devices that communicate using physical sidelink channels such as, but not limited to, Physical Sidelink Broadcast Channel (PSBCH), Physical Sidelink Downlink Channel (PSDCH), etc.

In some embodiments, the UE 502 may additionally communicate with an Access Point (AP) 506 via an over-the-air connection. The AP 506 may manage a Wireless Local Area Network (WLAN) connection, which may serve to offload some/all network traffic from the RAN 504. The connection between the UE 502 and the AP 506 may be consistent with any Institute of Electrical and Electronics Engineers (IEEE) 802.11 protocol.

The RAN 504 may include one or more access nodes, for example, Access Network (AN) 508. AN 508 may terminate air-interface protocols for the UE 502 by providing access stratum protocols, such as RRC, Packet Data Convergence Protocol (PDCP), Radio Link Control RLC, Medium Access Control (MAC), and Layer 1 (L1) protocols. In this manner, the AN 508 may enable data/voice connectivity between the CN 520 and the UE 502. In some embodiments, the AN 508 may be implemented in a discrete device or as one or more software entities running on server computers as part of, for example, a virtual network. The AN 508 may be referred to as a BS, gNB, etc.

The RAN 504 is communicatively coupled to CN 520, which includes network elements to provide various functions to support data and telecommunications services to customers/subscribers (for example, users of UE 502). The components of the Core Network (CN) 520 may be implemented in one physical node or separate physical nodes.

In some embodiments, the CN 520 may be an LTE CN 522, which may also be referred to as an Evolved Packet Core (EPC). The LTE CN 522 may include Mobility Management Entity (MME) 524, Serving Gateway (SGW) 526, Serving General Packet Radio Service (GPRS) Support Nod (SGSN) 528, Home Subscriber Server (HSS) 530, Public Data Network (PDN) Gateway (PGW) 532, and Policy Control and Charging Rules Function (PCRF) 534 coupled with one another over interfaces (or “reference points”) as shown.

In some embodiments, the CN 520 may be a 5G Core network (5GC) 540. The 5GC 540 may include an Authentication Server Function (AUSF) 542, Access and Mobility Management Function (AMF) 544, Session Management Function (SMF) 546, User Plane Function (UPF) 548, Network Slice Selection Function (NSSF) 550, Network Exposure Function (NEF) 552, Network Function (NF) Repository Function (NRF) 554, Policy Control Function (PCF) 556, Unified Data Management (UDM) 558, and Application Function (AF) 560 coupled with one another over interfaces (or “reference points”) as shown.

The data network (DN) 536 may represent various network operator services, Internet access, or third-party services that may be provided by one or more servers, including, for example, application/content server 538.

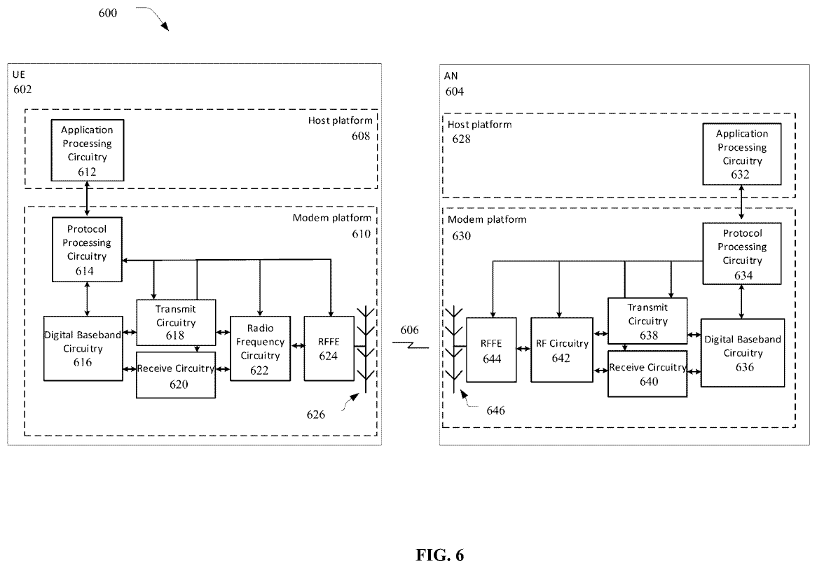

FIG. 6 schematically illustrates a wireless network 600 in accordance with various embodiments. The wireless network 600 may include a UE 602 in wireless communication with an AN 604. The UE 602 and AN 604 may be similar to, and substantially interchangeable with, like-named components described elsewhere herein.

The UE 602 may be communicatively coupled with the AN 604 via connection 606. The connection 606 is illustrated as an air interface to enable communicative coupling, and can be consistent with cellular communications protocols, such as an LTE protocol or a 5G NR protocol operating at mmWave or sub-6 GHZ frequencies.

The UE 602 may include a host platform 608 coupled with a modem platform 610. The host platform 608 may include application processing circuitry 612, which may be coupled with protocol processing circuitry 614 of the modem platform 610. The application processing circuitry 612 may run various applications for the UE 602 that source/sink application data. The application processing circuitry 612 may further implement one or more layer operations to transmit/receive application data to/from a data network.

The protocol processing circuitry 614 may implement one or more of layer operations to facilitate transmission or reception of data over the connection 606.

The modem platform 610 may further include digital baseband circuitry 616 that may implement one or more layer operations that are “below” layer operations performed by the protocol processing circuitry 614 in a network protocol stack.

The modem platform 610 may further include transmit circuitry 618, receive circuitry 620, Radio Frequency (RF) circuitry 622, and RF front end (RFFE) 624, which may include or connect to one or more antenna panels 626. The selection and arrangement of the components of the transmit circuitry 618, receive circuitry 620, RF circuitry 622, RFFE 624, and antenna panels 626 (referred generically as “transmit/receive components”) may be specific to details of a specific implementation such as, for example, whether communication is Time Division Multiplexing (TDM) or Frequency Division Multiplex (FDM), in mm Wave or sub-6 gHz frequencies, etc.

A UE reception may be established by the antenna panels 626, RFFE 624, RF circuitry 622, receive circuitry 620, digital baseband circuitry 616, and protocol processing circuitry 614. In some embodiments, the antenna panels 626 may receive a transmission from the AN 604 by receive-beamforming signals received by a plurality of antennas/antenna elements of the one or more antenna panels 626.

A UE transmission may be established by the protocol processing circuitry 614, digital baseband circuitry 616, transmit circuitry 618, RF circuitry 622, RFFE 624, and antenna panels 626. In some embodiments, the transmit components of the UE 604 may apply a spatial filter to the data to be transmitted to form a transmit beam emitted by the antenna elements of the antenna panels 626.

Similar to the UE 602, the AN 604 may include a host platform 628 coupled with a modem platform 630. The host platform 628 may include application processing circuitry 632 coupled with protocol processing circuitry 634 of the modem platform 630. The modem platform may further include digital baseband circuitry 636, transmit circuitry 638, receive circuitry 640, RF circuitry 642, RFFE circuitry 644, and antenna panels 646. The components of the AN 604 may be similar to and substantially interchangeable with like-named components of the UE 602.

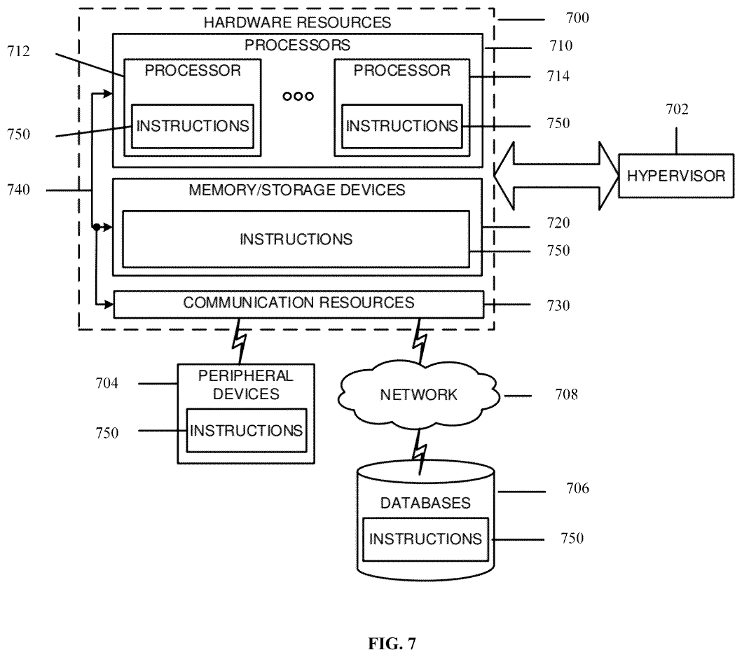

FIG. 7 is a block diagram illustrating components according to some example embodiments. The components illustrated in FIG. 7 can read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700, which comprises one or more processors (or processor cores) 710, one or more memory/storage devices 720, and one or more communication resources 730, each of which may be communicatively coupled via a bus 740 or interface circuitry. For embodiments where node virtualization (e.g., Network Functions Virtualization (NFV)) is utilized, a hypervisor 702 may be executed to provide an execution environment for one or more network slices/sub-slices to use the hardware resources 700.

The processors 710 may include, for example, a processor 712 and a processor 714. The processors 710 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 720 may include main memory, disk storage, or any suitable combination thereof. The memory/storage devices 720 may include, but are not limited to, any volatile, non-volatile, or semi-volatile memory such as dynamic random access memory (DRAM), static random access memory (SRAM), etc.

The communication resources 730 may include interconnection or network interface controllers, components, or other suitable devices to communicate with one or more peripheral devices 704 or one or more databases 706 or other network elements via network 708.

Instructions 750 may comprise software, a program, an application, an applet, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706.

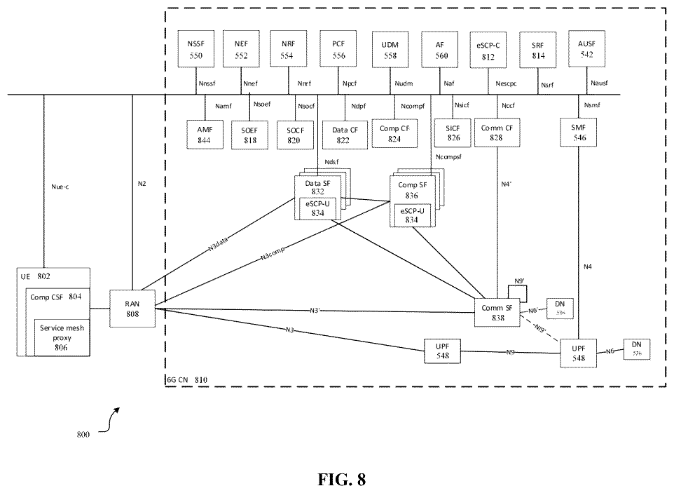

FIG. 8 illustrates a network 800 in accordance with various embodiments. The network 800 may operate in a manner consistent with 3GPP technical specifications or technical reports for 6G systems. In some embodiments, the network 800 may operate concurrently with network 500. For example, in some embodiments, the network 800 may share one or more frequency or bandwidth resources with network 500. As one specific example, a UE (e.g., UE 802) may be configured to operate in both network 800 and network 500. In general, several elements of network 800 may share one or more characteristics with elements of network 500. For the sake of brevity and clarity, such elements may not be repeated in the description of network 800.

The network 800 may include a UE 802, which may include any mobile or non-mobile computing device designed to communicate with a RAN 808 via an over-the-air connection. The UE 802 may be similar to, for example, UE 502.

The UE 802 and the RAN 808 may be configured to communicate via an air interface that may be referred to as a sixth-generation (6G) air interface.

The RAN 808 may allow for communication between the UE 802 and a 6G core network (CN) 810. Specifically, the RAN 808 may facilitate the transmission and reception of data between the UE 802 and the 6G CN 810. The 6G CN 810 may include various functions such as NSSF 550, NEF 552, NRF 554, PCF 556, UDM 558, AF 560, SMF 546, and AUSF 542. The 6G CN 810 may additionally include UPF 548 and DN 536 as shown in FIG. 8.

Additionally, the RAN 808 may include various additional functions that are in addition to, or alternative to, functions of a legacy cellular network, such as a 4G or 5G network. Two such functions may include a Compute Control Function (Comp CF) 824 and a Compute Service Function (Comp SF) 836. The Comp CF 824 and the Comp SF 836 may be parts or functions of the Computing Service Plane.

Two other such functions may include a Communication Control Function (Comm CF) 828 and a Communication Service Function (Comm SF) 838, which may be parts of the Communication Service Plane. The Comm CF 828 may be the control plane function for managing the Comm SF 838, communication sessions creation/configuration/releasing, and managing communication session context. The Comm SF 838 may be a user plane function for data transport.

Two other such functions may include a Data Control Function (Data CF) 822 and a Data Service Function (Data SF) 832, which may be parts of the Data Service Plane. Data CF 822 may be a control plane function and provides functionalities such as Data SF 832 management, Data service creation/configuration/releasing, Data service context management, etc. Data SF 832 may be a user plane function and serve as the gateway between data service users (such as UE 802 and the various functions of the 6G CN 810) and data service endpoints behind the gateway.

Another such function may be the Service Orchestration and Chaining Function (SOCF) 820, which may discover, orchestrate and chain up communication/computing/data services provided by functions in the network. Upon receiving service requests from users, SOCF 820 may interact with one or more of Comp CF 824, Comm CF 828, and Data CF 822 to identify Comp SF 836, Comm SF 838, and Data SF 832 instances, configure service resources, and generate the service chain, which could contain multiple Comp SF 836, Comm SF 838, and Data SF 832 instances and their associated computing endpoints.

Another such function may be the service registration function (SRF) 814, which may act as a registry for system services provided in the user plane, such as services provided by service endpoints behind Comp SF 836 and Data SF 832 gateways and services provided by the UE 802. The SRF 814 may be considered a counterpart of NRF 554, which may act as the registry for network functions.

Other such functions may include an evolved service communication proxy (eSCP) and service infrastructure control function (SICF) 826, which may provide service communication infrastructure for control plane services and user plane services. The eSCP may be related to the service communication proxy (SCP) of 5G with user plane service communication proxy capabilities being added. The eSCP is therefore expressed in two parts: eSCP-C 812 and eSCP-U 834, for control plane service communication proxy and user plane service communication proxy, respectively.

Another such function is the AMF 844. The AMF 844 may be similar to 544, but with additional functionality. Specifically, the AMF 844 may include potential functional repartition, such as moving the message forwarding functionality from the AMF 844 to the RAN 808.

Another such function is the service orchestration exposure function (SOEF) 818. The SOEF may be configured to expose service orchestration and chaining services to external users, such as applications.

The UE 802 may include an additional function that is referred to as a computing client service function (comp CSF) 804. The comp CSF 804 may have both the control plane functionalities and user plane functionalities, and may interact with corresponding network side functions such as SOCF 820, Comp CF 824, Comp SF 836, Data CF 822, and/or Data SF 832 for service discovery, request/response, compute task workload exchange, etc. The comp CSF 804 may also work with network side functions to decide on whether a computing task should be run on the UE 802, the RAN 808, and/or an element of the 6G CN 810.

The UE 802 and/or the comp CSF 804 may include a service mesh proxy 806. The service mesh proxy 806 may act as a proxy for service-to-service communication in the user plane. The capabilities of the service mesh proxy 806 may include one or more of addressing, security, load balancing, etc.

In some embodiments, the electronic device(s), network(s), system(s), chip(s) or component(s), or portions or implementations thereof, of FIGS. 5-8, may be configured to perform one or more processes, techniques, or methods as described herein, or portions thereof.

### EXAMPLES

The following paragraphs describe examples of various embodiments.

Example 1 includes an apparatus, comprising: interface circuitry; and processor circuitry coupled with the interface circuitry, wherein the processor circuitry is to: monitor a physical downlink control channel (PDCCH) on a bandwidth part (BWP) via the interface circuitry; decode a downlink control information (DCI) in the PDCCH; and receive, in response to at least one field in the DCI indicating to schedule multiple physical downlink shared channels (PDSCHs) and/or physical uplink shared channels (PUSCHs) on a plurality of concurrently active BWPs, the PDSCHs on the plurality of concurrently active BWPs via the interface circuitry.

Example 2 includes the apparatus of Example 1 or any other Examples herein, wherein the processor circuitry is further to: send the PUSCHs in the plurality of concurrently active BWPs via the interface circuitry.

Example 3 includes the apparatus of Example 1 or any other Examples herein, wherein the field is a single type 1 field to indicate common information for the plurality of concurrently active BWPs.

Example 4 includes the apparatus of Example 1 or any other Examples herein, wherein the field is a single type 2 field to indicate one row of a first table configured by higher layers, and each row of the first table defines a complete set of per-BWP configuration parameters for the plurality of concurrently active BWPs.

Example 5 includes the apparatus of Example 4 or any other Examples herein, wherein the size of the type 2 field is determined based on the number of rows for the first table.

Example 6 includes the apparatus of Example 1 or any other Examples herein, wherein the field is a single type 3 field to indicate information for only one of the plurality of concurrently active BWPs.

Example 7 includes the apparatus of Example 1 or any other Examples herein, wherein the fields are type 4 fields to indicate information for each of the plurality of concurrently active BWPs.

Example 8 includes the apparatus of Example 7 or any other Examples herein, one parameter is configured by radio resource control (RRC) signaling to indicate whether one of the type 1 field, the type 2 field, the type 3 field, and the type 4 field is applied to the fields in the DCI.

Example 9 includes the apparatus of Example 1 or any other Examples herein, wherein the field is to indicate one entry of a second table, and wherein each entry of the second table indicates one combination of concurrently active BWPs from an available set of BWPs.

Example 10 includes the apparatus of Example 9 or any other Examples herein, wherein one entry of the second table includes only one BWP to enable dynamic switching between a single BWP and the plurality of concurrently active BWPs scheduling.

Example 11 includes the apparatus of Example 1 or any other Examples herein, wherein the plurality of concurrently active BWPs are non-overlapping or separate from each other in the frequency domain.

Example 12 includes an apparatus, comprising: interface circuitry; and processor circuitry coupled with the interface circuitry, wherein the processor circuitry is to: send a downlink control information (DCI) in a physical downlink control channel (PDCCH) via the interface circuitry, and wherein at least one field is included in the DCI for scheduling multiple physical downlink shared channels (PDSCHs) and/or physical uplink shared channels (PUSCHs) on a plurality of concurrently active bandwidth parts (BWPs).

Example 13 includes the apparatus of Example 12 or any other Examples herein, wherein the processor circuitry is further to: send the PDSCHs on the plurality of concurrently active BWPs via the interface circuitry.

Example 14 includes the apparatus of Example 12 or any other Examples herein, wherein the field is a single type 1 field to indicate common information for the plurality of concurrently active BWPs.

Example 15 includes the apparatus of Example 12 or any other Examples herein, wherein the field is a single type 2 field to indicate one row of a first table configured by higher layers, and each row of the first table defines a complete set of per-BWP configuration parameters for the plurality of concurrently active BWPs.

Example 16 includes the apparatus of Example 15 or any other Examples herein, wherein the size of the type 2 field is determined based on the number of rows for the first table.

Example 17 includes the apparatus of Example 12 or any other Examples herein, wherein the field is a single type 3 field to indicate information for only one of the plurality of concurrently active BWPs.

Example 18 includes the apparatus of Example 12 or any other Examples herein, wherein the fields are type 4 fields to indicate information for each of the plurality of concurrently active BWPs.

Example 19 includes the apparatus of Example 18 or any other Examples herein, one parameter is configured by radio resource control (RRC) signaling to indicate whether one of the type 1 field, the type 2 field, the type 3 field, and the type 4 field is applied to the fields in the DCI.

Example 20 includes the apparatus of Example 12 or any other Examples herein, wherein the field is to indicate one entry of a second table, and wherein each entry of the second table indicates one combination of concurrently active BWPs from an available set of BWPs.

Example 21 includes the apparatus of Example 20 or any other Examples herein, wherein one entry of the second table includes only one BWP to enable dynamic switching between a single BWP and the plurality of concurrently active BWPs scheduling.

Example 22 includes the apparatus of Example 12 or any other Examples herein, wherein the plurality of concurrently active BWPs are non-overlapping or separate from each other in the frequency domain.

Example 23 includes a method, comprising: monitoring a physical downlink control channel (PDCCH) on a bandwidth part (BWP) via the interface circuitry; decoding a downlink control information (DCI) in the PDCCH; and receiving, in response to at least one field in the DCI indicating to schedule multiple physical downlink shared channels (PDSCHs) and/or physical uplink shared channels (PUSCHs) on a plurality of concurrently active BWPs, the PDSCHs on the plurality of concurrently active BWPs via the interface circuitry.

Example 24 includes the method of Example 23 or any other Examples herein, further comprising: sending the PUSCHs in the plurality of concurrently active BWPs via the interface circuitry.

Example 25 includes the method of Example 23 or any other Examples herein, wherein the field is a single type 1 field to indicate common information for the plurality of concurrently active BWPs.

Example 26 includes the method of Example 23 or any other Examples herein, wherein the field is a single type 2 field to indicate one row of a first table configured by higher layers, and each row of the first table defines a complete set of per-BWP configuration parameters for the plurality of concurrently active BWPs.

Example 27 includes the method of Example 26 or any other Examples herein, wherein the size of the type 2 field is determined based on the number of rows for the first table.

Example 28 includes the method of Example 23 or any other Examples herein, wherein the field is a single type 3 field to indicate information for only one of the plurality of concurrently active BWPs.

Example 29 includes the method of Example 23 or any other Examples herein, wherein the fields are type 4 fields to indicate information for each of the plurality of concurrently active BWPs.

Example 30 includes the method of Example 29 or any other Examples herein, one parameter is configured by radio resource control (RRC) signaling to indicate whether one of the type 1 field, the type 2 field, the type 3 field, and the type 4 field is applied to the fields in the DCI.

Example 31 includes the method of Example 23 or any other Examples herein, wherein the field is to indicate one entry of a second table, and wherein each entry of the second table indicates one combination of concurrently active BWPs from an available set of BWPs.

Example 32 includes the method of Example 31 or any other Examples herein, wherein one entry of the second table includes only one BWP to enable dynamic switching between a single BWP and the plurality of concurrently active BWPs scheduling.

Example 33 includes the method of Example 23 or any other Examples herein, wherein the plurality of concurrently active BWPs are non-overlapping or separate from each other in the frequency domain.

Example 34 includes a method, comprising: sending a downlink control information (DCI) in a physical downlink control channel (PDCCH) via the interface circuitry, and wherein at least one field is included in the DCI for scheduling multiple physical downlink shared channels (PDSCHs) and/or physical uplink shared channels (PUSCHs) on a plurality of concurrently active bandwidth parts (BWPs).

Example 35 includes the method of Example 34 or any other Examples herein, further comprising: sending the PDSCHs on the plurality of concurrently active BWPs via the interface circuitry.

Example 36 includes the method of Example 34 or any other Examples herein, wherein the field is a single type 1 field to indicate common information for the plurality of concurrently active BWPs.

Example 37 includes the method of Example 34 or any other Examples herein, wherein the field is a single type 2 field to indicate one row of a first table configured by higher layers, and each row of the first table defines a complete set of per-BWP configuration parameters for the plurality of concurrently active BWPs.

Example 38 includes the method of Example 37 or any other Examples herein, wherein the size of the type 2 field is determined based on the number of rows for the first table.

Example 39 includes the method of Example 34 or any other Examples herein, wherein the field is a single type 3 field to indicate information for only one of the plurality of concurrently active BWPs.

Example 40 includes the method of Example 34 or any other Examples herein, wherein the fields are type 4 fields to indicate information for each of the plurality of concurrently active BWPs.

Example 41 includes the method of Example 40 or any other Examples herein, one parameter is configured by radio resource control (RRC) signaling to indicate whether one of the type 1 field, the type 2 field, the type 3 field, and the type 4 field is applied to the fields in the DCI.

Example 42 includes the method of Example 34 or any other Examples herein, wherein the field is to indicate one entry of a second table, and wherein each entry of the second table indicates one combination of concurrently active BWPs from an available set of BWPs.

Example 43 includes the method of Example 42 or any other Examples herein, wherein one entry of the second table includes only one BWP to enable dynamic switching between a single BWP and the plurality of concurrently active BWPs scheduling.

Example 44 includes the method of Example 34 or any other Examples herein, wherein the plurality of concurrently active BWPs are non-overlapping or separate from each other in the frequency domain.

Example 45 includes an apparatus comprising means for performing the method of any of Examples 23 to 33.

Example 46 includes an apparatus comprising means for performing the method of any of Examples 34 to 44.

Example 47 includes a computer-readable medium having instructions stored thereon, wherein the instructions, when executed by processing circuitry, cause the processing circuitry to perform the method of any of Examples 23 to 33.

Example 48 includes a computer-readable medium having instructions stored thereon, wherein the instructions, when executed by processing circuitry, cause the processing circuitry to perform the method of any of Examples 34 to 44.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that the embodiments described herein be limited only by the appended claims and the equivalents thereof.

What is claimed is:

1. An apparatus, comprising:
interface circuitry; and
processor circuitry coupled with the interface circuitry,
wherein the processor circuitry is to:
monitor a physical downlink control channel (PDCCH) on a bandwidth part (BWP) via the interface circuitry;
decode a downlink control information (DCI) in the PDCCH; and
receive, in response to at least one field in the DCI indicating to schedule multiple physical downlink shared channels (PDSCHs) and/or physical uplink shared channels (PUSCHs) on a plurality of concurrently active BWPs, the PDSCHs on the plurality of concurrently active BWPs via the interface circuitry.

2. The apparatus of claim 1, the processor circuitry is further to:
send the PUSCHs in the plurality of concurrently active BWPs via the interface circuitry.

3. The apparatus of claim 1, wherein the field is a single type 1 field to indicate common information for the plurality of concurrently active BWPs.

4. The apparatus of claim 1, wherein the field is a single type 2 field to indicate one row of a first table configured by higher layers, and each row of the first table defines a complete set of per-BWP configuration parameters for the plurality of concurrently active BWPs.

5. The apparatus of claim 4, wherein the size of the type 2 field is determined based on the number of rows for the first table.

6. The apparatus of claim 1, wherein the field is a single type 3 field to indicate information for only one of the plurality of concurrently active BWPs.

7. The apparatus of claim 1, wherein the fields are type 4 fields to indicate information for each of the plurality of concurrently active BWPs.

8. The apparatus of claim 7, one parameter is configured by radio resource control (RRC) signaling to indicate whether one of the type 1 field, the type 2 field, the type 3 field, and the type 4 field is applied to the fields in the DCI.

9. The apparatus of claim 1, wherein the field is to indicate one entry of a second table, and wherein each entry of the second table indicates one combination of concurrently active BWPs from an available set of BWPs.

10. The apparatus of claim 9, wherein one entry of the second table includes only one BWP to enable dynamic switching between a single BWP and the plurality of concurrently active BWPs scheduling.

11. An apparatus, comprising:
interface circuitry; and
processor circuitry coupled with the interface circuitry,
wherein the processor circuitry is to:
send a downlink control information (DCI) in a physical downlink control channel (PDCCH) via the interface circuitry, and wherein at least one field is included in the DCI for scheduling multiple physical downlink shared channels (PDSCHs) and/or physical uplink shared channels (PUSCHs) on a plurality of concurrently active bandwidth parts (BWPs).

12. The apparatus of claim 11, the processor circuitry is further to:
send the PDSCHs on the plurality of concurrently active BWPs via the interface circuitry.

13. The apparatus of claim 11, wherein the field is a single type 1 field to indicate common information for the plurality of concurrently active BWPs.

14. The apparatus of claim 11, wherein the field is a single type 2 field to indicate one row of a first table configured by higher layers, and each row of the first table defines a complete set of per-BWP configuration parameters for the plurality of concurrently active BWPs.

15. The apparatus of claim 14, wherein the size of the type 2 field is determined based on the number of rows for the first table.

16. The apparatus of claim 11, wherein the field is a single type 3 field to indicate information for only one of the plurality of concurrently active BWPs.

17. The apparatus of claim 11, wherein the fields are separate type 4 fields to indicate information for each of the plurality of concurrently active BWPs.

18. The apparatus of claim 17, one parameter is configured by radio resource control (RRC) signaling to indicate whether one of the type 1 field, the type 2 field, the type 3 field, and the type 4 field is applied to the fields in the DCI.

19. The apparatus of claim 11, wherein the field is to indicate one entry of a second table, and wherein each entry of the second table indicates one combination of concurrently active BWPs from an available set of BWPs.

20. The apparatus of claim 19, wherein one entry of the second table includes only one active BWP to enable dynamic switching between a single BWP and the plurality of concurrently active BWPs scheduling.
